(19) United States
(12) Patent Application Publication
(10) Pub. No.: US 2005/0025920 A1
(43) Pub. Date: Feb. 3, 2005

(54) Thermoplastic multilayer composite in the form of a hollow body

(76) Inventors: Alex Stolarz, Bonaduz (CH); Albert Flepp, Domat/Ems (CH); Andre Sturzel, Igis (CH); Georg Stoppelmann, Bonaduz (CH)

Correspondence Address: Finnegan, Henderson, Farabow,;Garrett & Dunner, L.L.P., 1300 I Street, N.W., Washington, DC, 20005-3315, US

(21) Appl. No.: 10/784,946

(22) Filed: Feb. 25, 2004

Related U.S. Application Data
(60) Provisional application No. 60/454,334, filed on Mar. 14, 2003.

(30) Foreign Application Priority Data
Feb. 28, 2003 (CH) 0311/03

(51) Int. Cl. B32B 1/08

(52) U.S. Cl. 428/35.7; 428/36.91

(57) ABSTRACT

The present invention refers to a thermoplastic multilayer composite (4) in the form of a hollow body which is formed by at least one inner layer (1) on the basis of polyamides, at least one inter-mediate layer (2) as well as at least one thermoplastic outer layer (3). Furthermore, the present invention relates to a process for making such a thermoplastic multilayer composite as well as to the use of such a thermoplastic multilayer composite as a tubing in particular for fuels. In particular in the context of the use as a tubing for fuels the proposed multiplayer structure shows to be surprisingly resistant against petrol comprising peroxide while at the same time having a simple structure, if the inner layer (1) is based on a mixture of different polyamide homopolymers.

### TECHNICAL FIELD

The present invention refers to a thermoplastic multilayer composite in the form of a hollow body which is formed by at least one inner layer on the basis of polyamides, at least one inter-mediate layer as well as at least one thermoplastic outer layer. Furthermore, the present invention relates to a process for making such a thermoplastic multilayer composite as well as to the use of such a thermoplastic multilayer composite. The term hollow body shall be understood to also include hollow profiles such as multilayer hoses, or a multilayer tube or multilayer pipe but shall also include multilayer containers.

### STATE OF THE ART

For a long time, motor vehicles have been equipped with fuel tubings made of polyamide. Initially, to this end mono layer tubes have been used, these have however increasingly been replaced by motor vehicle multilayer tubings in view of the required values of the permeability and in view of the required impact strength. Such tubes show a high thermoresistance, a high stability with respect to their length as well as a high resistance and low permeability not only for the main components of the transported fuel, but also for additives or side components which are present, like for example alcoholic components, aromatic components etc.

Such a multilayer motor vehicle tubing is for example described in the German patent specification DE 40 06 870 C1. The fuel tubing described therein is characterised in a high cold impact strength and a high stability with respect to its length, can be subjected to short time thermostress and is made of at least three layers. The inner as well as the outer layer are made of impact strength modified polyamide which may or may not contain softener. Preferably for the inner layer polyamide 6 is given, while for the outer layer polyamide 6, 11, 12 or 1212 are proposed.

As the intermediate layer, that is as the so called barrier layer, also polyamides are given, in particular polyamide 66 and polyamide elastomers on the basis of polyamide 12 are mentioned. The use of such polyamides as barrier layers leads to an increased barrier effect with respect to the usually toxic aromatic components of the fuels.

Another multilayer motor vehicle tubing on the basis of polyamide is disclosed in the German utility model G 92 03 865.4 U1. Again this document describes a tubing comprising three layers, wherein also in this case for the inner and/or the outer layer impact strength modified homo- and copolyamides are used including the elastomeric copolyamides. In a preferred embodiment to this end polyamide 6, polyamide 11 as well as polyamide 12 are proposed. As barrier layer in the middle between these two layers of polyamide ethylene/vinyl alcohol-copolymers (EVOH) are proposed. To provide sufficient adhesion between this intermediate layer and the outer layers made of polyamide an additional intermediate layer made of a polyamide elastomer, for example made of an elastomeric copolyamide of the group of polyetherpolyamides or of polyetherester-polyamides are given.

In the context of an intermediate layer as a barrier layer attention should also be drawn to the Japanese lay open JP 07-308996. To reduce stress crack formation this document proposes to provide the layer of ethylene/vinyl alcohol-copolymers partially with a polyamide-copolymer. As a copolymer among others a copolymer made of polyamide 6 and polyamide 12 (copolyamide 6/12) is given.

In particular in the context of the problems associated with bending of such tubings attention should also be drawn to U.S. Pat. No. 5,469,892, which comprises bellow-like regions which simplify bending of such tubings without problems. In this document a three layer structure is disclosed wherein the outer layer is made of polyamide 12, polyamide 11 or polyamide 6. As an option it is additionally pointed out that such an outer layer may be provided as a multi component system, wherein among others a mixture of nylon-6-copolymers with other nylons is proposed. As an inner layer polyamide 12, polyamide 11, polyamide 6 are proposed as thermoplastic material and mixtures thereof. Again the possibility is outlined that also for the inner layer nylon-6-copolymers can be mixed with other nylons and if need be with olefinic components. As an intermediate layer a layer without polyamide constituents is disclosed which provides adhesion with the two outer layers. In a preferred embodiment among others the use of ethylene/vinyl alcohol-copolymers (EVOH) is disclosed.

DE 101 10 964 A1also discloses a thermoplastic multilayer composite for use as a tubing for fuels. In this case the tubing comprises a structure of four layers, wherein as an inner layer a layer on the basis of polyamide 6, polyamide 46, polyamide 66, polyamide 69, polyamide 610 or polyamide 612 is proposed, followed by a moulding compound on the basis of ethylene/vinyl alcohol-copolymers. On the one side, this EVOH layer is followed by an adhesion providing moulding compound on the basis of copolyamide 6/12 or a polyamide mixture. Among others mixtures of polyamide 6 and polyamide 12 with compatibilizers are proposed as such moulding compound. Towards the outer side such a tubing is limited by a layer on the basis of polyamide 12, polyamide 11, polyamide 1010, polyamide 1012 or polyamide 1212.

As more recent state-of-the-art attention should also be drawn to EP 1 077 341 A2, which discloses a motor vehicle multilayer tubing, the inner layer of which comprises a fluoro polymer which is made electrically conductive. This acts as a barrier and is followed by another layer made of fluoro polymer, which can be extruded at a temperature of 600° Fahrenheit (approx. 315° C.). This layer is followed by a layer providing adhesion, wherein this layer can be mixtures of polymers. In a coextrusion process as the outer layer among others copolymers or mixtures of polymers are proposed, wherein a multitude of modular components are possible, such as for example various polyamides, polyester, polyurethane, polyvinyl chloride etc.

EP 1 216 826 A2 in principle discloses a multi layer composite which is made using a moulding compound of polyamide (preferentially polyamide 6, polyamide 66 or polyamide 6/66 as well as mixtures thereof), optionally provided with polyamine-polyamide-copolymers as well as with parts in weights of another polyamide (preferentially polyamide 11, polyamide 12, polyamide 612, polyamide 1012, polyamide 1212 as well as mixtures thereof) and which adjacent to this layer comprises a layer made of ethylene/vinyl alcohol-copolymer. The layer of polyamide is preferentially provided on the outer side of a tubing. Essentially the aim of this document is to add a polyamide-copolymer as a compatiblizer to the moulding compound of polyamide, or to, in the absence of such a polyamide-copolymer work at a compounding temperature which is sufficiently high to lead to reamidations, which when compounding lead to polyamide-blockcopolymers taking over the function of the compatibilizers. This process is preferentially supported by the addition of corresponding catalysers like for example hypophosphoric acid, diabutyltinoxide, triphenylphosphin or phosphoric acid.

### SUMMARY OF THE INVENTION

It is an object of the present invention to provide a multilayer composite for hollow bodies superior with respect to the multilayer motor vehicle tubings according to the state-of-the-art. In particular, this composite shall be resistant from the inner side with respect to petrol comprising peroxides (so called sour-gas resistance, wherein gas stands for gasoline), shall comply with the typical requirements with respect to cold impact, and shall additionally have a simple and cost effective structure. In detail a thermoplastic multilayer composite is proposed comprising at least one inner layer on the basis of polyamides, at least one intermediate layer as well as at least one thermoplastic outer layer. The hollow body may have the form a multilayer hose, of a multilayer pipe or of a multilayer container.

This object is attained in that the inner layer is formed by a mixture on the basis of different polyamide-homopolymers.

The core of the invention therefore resides in the fact that the inner layer is not, as usual according to the state-of-the-art, formed on the basis of one single polyamide-homopolymer or on the basis of a mixture with polyamide-6-copolymers, but to use a blend (a mixture) of different polyamide-homopolymers. Surprisingly, it can be shown that such blends, which are typically used as adhesion providing intermediate layers, can also be used as an inner layer showing a out-standing stability with respect to peroxide. Furthermore, since they have good adhesion properties, they eliminate the need for another adhesive element to the intermediate layer which inter-mediate layer typically takes over the barrier function. This allows building simple structure while fulfilling the same function. When connecting such tubings to metal pipe connections, also the resistance of the inner layer with respect to zinc chloride according to the invention is a significant advantage.

A first preferred embodiment of the present invention is characterised in that the inner layer additionally comprises a compatibilizer. Typically, such mixtures, which are mixed from different polyamide-homopolymers, are only stable if corresponding compatibilizers are added.

In the context of the present invention it has to be pointed out that within the meaning of the term of a polyamide-homopolymer, in contrast to polyamide-copolymers, not only homopolymers within the narrow meaning, that is homopolymers, within which the individual monomer elements are strictly identical, shall be understood. Within the term polyamide-homopolymers in the present context according to general practice also polyamide like for example polyamide 66, polyamide 1012, or polyamide 1212, which make use of two different monomers (diamin and dicarbonic acid) shall be included. Substantial for the delimitation with respect to copolymers is the fact that polyamide-homopolymers thus defined in a broader sense, the molar ratio between the two monomers can not be varied but is fixed (1:1), because the two monomers due to their reactive groups can only be incorporated into the polymer chain in a strictly alternating manner. It thus generally results a polyamide with constant main properties (for example melting temperature).

According to another preferred embodiment of the present invention the inner layer is made of a mixture of at least two components, wherein the first component is a polyamide-homopolymer selected from the group polyamide 6, or polyamide 66, and wherein the second component is a polyamide-homopolymer selected from the group of polyamide 12, polyamide 11, polyamide 1010, polyamide 1212 or polyamide 1012. Particularly suitable seems to be a mixture or blend, respectively, of polyamide 6 and polyamide 12, wherein this blend may additionally comprise further components (further polyamides, additives). The first component of polyamide 6 preferentially has an MVR-value in the range of 20 to 50, preferentially in the range of 25 to 35. The second component of polyamide 12 preferentially has an MVR-value in the range of 10 to 40, preferentially in the range of 15 to 25.

The MVR-value (formally also designated MVI-value) is the Melt Volume Ratio in cm³ per 10 minutes, measured after a melting time of 4 minutes and in the present case at 275° C. and at a load of 5 kg, according to DIN ISO 1133:1991.

If such a mixture of polyamides with addition of a corresponding compatibilizer (which is not a copolyamide) is processed, i.e. compounded or extruded, this may be done at temperatures below 280° C. Preferred is a temperature smaller than or equal to 250° C. Particularly suited is a range between 230° and 240° C.

It can be shown that such a blend shows good properties, if the weight ratio of the first component to the second component is in a range of 2:3 to 3:2. Particularly preferred is a range of the weight ratios of these two components between 2:3 to 1:1.

An other preferred embodiment is characterised in that the inner layer additionally comprises a compatibilizer, wherein this compatibilizer is present in a proportion in the range of 0-30 parts in weight, with reference to the total of parts in weight of polyamides and compatibilizer. Particularly advantageous is a proportion of 0-20 parts in weight and particularly advantageous is a proportion of 5-15 parts in weight. As compatiblizers impact strength modifiers, elastomers or rubbers can be used. Rubbers for use as impact strength modifiers are for example disclosed in EP 0 654 505 A1 and are known from this document. They usually comprise an elastomeric part and at least one functional group which can react with a polyamide like for example a carbonic acid or a carbonic acid anhydride group. Also mixtures of different impact strength modifiers can be used as compatiblizers. Particularly suitable proved to be acid modified ethylene/α-olefin-copolymers. As further additives for the inner layer flame retardant additives, pigments, stabilisers, strengtheners (for example glass fibres), softeners but also additives for providing electrical conductivity, i.e. antistatic additives (for example conducting carbon black or carbon fibres or graphite fibrils) can be used. Such additives however preferentially in total do not make up for more than 50 weight- % of the total moulding compound, wherein flame retardant additives may make up to 15 weight- %.

Due to the inherently good adhesion properties of the chosen mixture of different polyamide-homopolymers it is possible, as outlined in another preferred embodiment, to provide the inner layer immediately adjacent to the intermediate layer. With a corresponding choice of the outer layer, for example made of an identical or similar mixture of different polyamide-homopolymers like the inner layer, it is also possible to provide the intermediate layer immediately adjacent to the outer layer.

It is however also possible to provide additional layers between the inner layer and the intermediate layer. Such an additional intermediate layer between the inner layer and an intermediate layer preferentially made of ethylene/vinyl alcohol-copolymers can preferentially be made of a material on the basis of polyamide 6, on the basis of a copolymer like for example copolyamide 6/12, or on the basis of a polyolefin, which is preferentially functionalised, or mixtures thereof. Furthermore, preferentially an additional intermediate layer may be provided between the inter-mediate layer made of ethylene/vinyl alcohol-copolymers and the outer layer made of polyamide-blend, which additional intermediate layer is chosen from the same group of polymers as the possible inner intermediate layer.

A possible variant is to provide, between the inner and the outer layer, at least one intermediate layer, chosen from the materials mentioned in the previous paragraph, but without EVOH-intermediate layer.

According to another preferred embodiment the multilayer composite is provided as a hose. This for example if it is used as a petrol tubing or generally as a fuel tubing. The tubing may also be a filler neck or an airvent pipe. The tubes may be smooth or may at least partially comprise bellows. The term hose instead of tubing is sometimes used in the context of softened and highly flexible polymer types.

Preferred is also a design of the multilayer composite according to the invention as a container, e.g. as a fuel canister or a fuel tank.

The intermediate layer, which typically has the function of a barrier, can be made on the basis of ethylene/vinyl alcohol-copolymers. Preferably such intermediate layers are additionally provided with additives to improve mechanical properties like impact strength (in particular cold impact strength), stress crack resistance, elongation at break.

With respect to the outer layer it shows that this may be made of polyolefin or thermoplastic elastomer. It may however also advantageously be made of a mixture on the basis of different polyamide-homopolymers, wherein the polyamide preferably comprises at least two different polyamides, wherein again as a first component preferably polyamide 6 or polyamide 66 is used, and as a second component polyamide 12, polyamide 11, polyamide 1010, polyamide 1012 or polyamide 1212. In other words, it is possible and furthermore advantageous to provide an outer layer made of the same or a similar material as the inner layer. In particular if the outer layer is made of a mixture on the basis of polyamide 6 and preferably of polyamide 12, the result is a very good resistance with respect to zinc chloride, which in the context of the use as petrol tubing in motor vehicles is important. This because in winter the de-icing salt and zinc comprising metal parts from the motor vehicle may lead to zinc chloride, which for example attacks pure polyamide 6.

Preferably in this mixture the first component (polyamide 6) and the second component (preferably polyamide 12) are provided in a proportion of a weight ratio of 2:3 to 3:2, preferably in a weight ratio of 2:3 to 1:1.

The outer layer may additionally also comprise a compatibilizer, preferably in a proportion in the range of 0-30 parts in weight, with reference to the total of parts in weight of polyamides and compatibilizer. Particularly advantageous is the use of a proportion of 0-20 parts in weight, particularly preferred is a proportion of 5-15 parts in weight. Possible as compatibilizers are those already mentioned in the context of the inner layer further above, i.e. impact strength modifiers, elastomers or rubbers, in particular acid modified ethylene/α-olefin-copolymers.

Further preferred embodiments of the thermoplastic multilayer composite are outlined in the dependent claims.

Furthermore, the present invention relates to a process for making a thermoplastic multilayer composite as described above. In this process preferably the inner layers, the intermediate layer as well as the outer layer, and possibly further intermediate layer are joined in one coextrusion process, wherein the extrudate is formed to for example a tube, hose or container, respectively. This may be done continuously or discontinuously (for example by means of extrusion blow 20 moulding).

Furthermore, the present document relates to the use of a thermoplastic multilayer composite as described above preferentially as a fuel hose in particular for liquid fuels like petrol or diesel for example for combustion engines.

### SHORT DESCRIPTION OF THE FIGURES

In the following the invention shall be detailed by means of examples in the context with the drawing. It shows:

FIG. 1 an axial cut through a fuel hose with a multilayer structure.

### DESCRIPTION OF THE PREFERRED EMBODIMENT

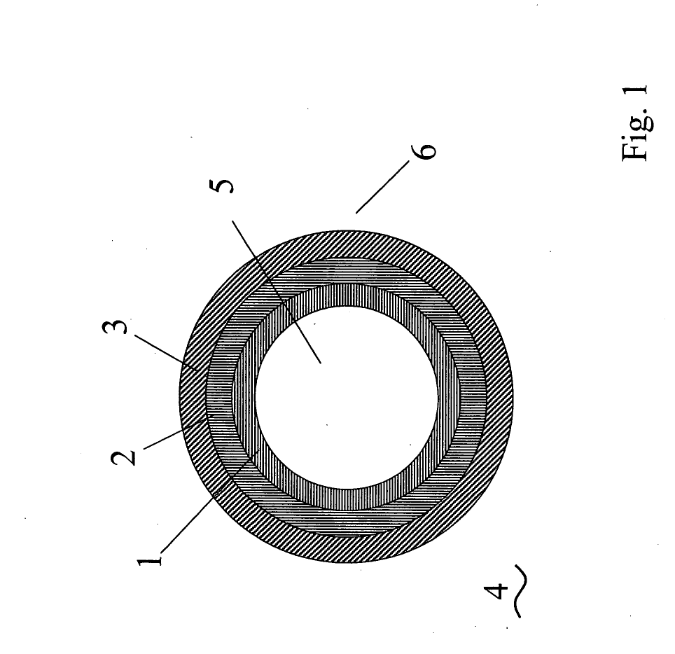

FIG. 1 shows a general structure of a fuel pipe made of a thermoplastic multilayer composite 4, which shall serve as an example for the present invention. The pipe comprises an inner space 5, which towards the outer side is first enclosed by an inner layer 1. Immediately adjacent to this inner layer 1 there is provided an intermediate layer 2, which typically serves as a barrier or a lock. The fuel pipe is limited towards the outer space 6 by means of an outer layer 3, which is located immediately adjacent to the intermediate layer 2. Such a simple structure of only three layers is possible if as an inner layer 1 a polymeric material is used, which on the one hand already provides sufficient adhesion properties to form a stable connection with the intermediate layer 2, and which on the other hand shows sufficient chemical resistance with respect to the fuels transported in the inner space 5. According to the state-of-the-art as for example disclosed in DE 101 10 964 A1, typically for such applications thermoplastic multilayer composites are used which comprise at least four or five layers.

According to the present invention it is proposed to use a mixture on the basis of different polyamide-homopolymers for the inner layer 1. Preferably a mixture of polyamide 6 and polyamide 12 is used. Such a blend, which typically up to now was used as an adhesion provider, surprisingly shows to be stable with respect to fuels and possibly present additives or often also present additional components like peroxide (so called sour gas resistance), etc. Additionally, the proposed layer may be provided immediately adjacent to the intermediate layer 2, since it already inherently shows sufficient adhesion properties with respect to typical intermediate layers 2.

In the present example as material for the inner layer 1 a mixture of 45 weight- % polyamide 6 and 45 weight- % polyamide 12 at 10% of an acid modified ethylene/α-olefin-copolymer as compatibilizers as well as stabilizers were used. This shall in the following be designated with GRILAMID® XE 3850, and is available under this name at EMS-CHEMIE AG, Domat/Ems, Switzerland.

The materials used were investigated for further characterisation with respect to the Melt Volume Rate MVR (Melt Volume Rate; formally MVI Melt Volume Index). The MVR-value is the Melt Volume Rate in cm³ per 10 minutes, measured after a melting time of 4 minutes at 275° C. and at a load of 5 kg, and it was measured according to DIN ISO 1133:1991. These measurements were carried out with the proposed mixture GRILAMID® XE 3850 for the inner layer as well as for the starting materials for the production of such mixtures.

The component made of polyamide 6 (first component of the blend) taken alone has a MVR-value in the range of 20 to 50, preferably in the range 25 to 35. The component of polyamide 12 (second component of the blend) taken alone has a MVR-value in the range of 10 to 40, preferably a value in the range of 15 to 25.

The mixture (blend including compatibilizer and stabilizer, GRILAMID® XE 3850) has an MVR-value in the range 5 to 20, preferred is a range of 5 to 15.

Alternatively, also a mixture as available under the name GRILAMID® XE 3795 at EMS-CHEMIE AG, Domat/Ems, Switzerland, can be used (product description according to ISO 1874:PA12/PA6/X,EG,18-020).

As material for the intermediate layer 2 (barrier- and inhibitor-layer) an ethylene/vinyl alcohol-copolymer (EVOH) was used. In the present example, a product of the company KURARAY, which is available under the name EVAL® under the product designation F101A, was used.

The intermediate layer 2 can be improved with respect to the tendency of stress cracks by addition of a copolyamide. Such an addition is for example detailed in the already mentioned JP 07-308996, and the content of this document shall be explicitly included at this position with respect to the addition a copolyamide. It can be shown that in particular in combination with a inner layer 1 according to the invention on the basis of a blend of polyamide-homopolymers such an addition of a copolyamide or a mixture of a copolyamides to the intermediate layer of EVOH leads to substantially improved stress crack properties, however leading to a decrease of the barrier effect.

As material for the outer layer 3 in the example the same material as for the inner layer 1 is used i.e. GRILAMID® XE 3850. It is however also possible to use other materials for the outer layer. It can be shown that in particular when using the mentioned GRILAMID® XE 3850 a very high resistance with respect to zinc chloride can be achieved.

Generally it has to be mentioned that it is possible to provide additional layers between the barrier layer 2 made of for example of EVOH and the inner layer and/or the outer layer, such additional layers may for example be made of polyamide 6 and/or copolyamide or of a graft polypropylene as available under the product name “Polymer XE 3135” at EMS-CHEMIE AG, Domat/Ems, Switzerland (i.e. a functionalised polyolefin), or to replace the intermediate layer 2 by means of a polyamide 6 or a copolyamide 6/12 or a polyolefin or by a blend of at least two of these components. Furthermore it is possible to provide, on top of the outer layer of GRILAMID® XE 3850, a further layer of a polyolefin, or a thermoplastic elastomer, or of polyamide 11, polyamide 12, respectively.

Preferred embodiments of the multi layer composite according to the invention are made antistatic in that the inner layer 1 or a supplemental inner layer on the basis of a polyamide-blend of layer 1 comprise additives which lead to electrical conductivity. Preferred electrically conductive additives are conductive carbon black, carbon fibres or graphite fibrils.

A tube or hose as given in FIG. 1 can be produced in a coextrusion process, in which the individual layers are extruded substantially at the same time as a multilayer composite. The coextrusion process is particularly simple if the tube only comprises three layers and if additionally the material for the inner and outer layer is identical.

For the verification of the properties the following examples (variants 1-5) have been measured:

TABLE 1

| | Inner layer (1) | Intermediate layer (2) | Intermediate layer | Outer layer (3) |
|---|---|---|---|---|
| Variant 1 | Grilon R50 HNZ | EVOH (EVAL) | | Grilon ELX 50 HNZ |
| Variant 2 | Grilon R47 HW | EVOH (EVAL) | | Grilon ELX23 NZ |
| Variant 3 | Grilon R47 HW | EVOH (EVAL) | adhesive | Grilamid L25 W20X |
| Variant 4 | Grilamid XE 3850 | EVOH (EVAL) | | Grilamid XE 3850 |
| Variant 5 | Grilamid XE 3850 | EVOH (EVAL) + | | Grilamid XE 3850 |
| | | 20% Grilon CF7 | | |

The variants 1to 3 are examples according to the state-of-the-art, while variants 4 and 5 are examples according to the invention. The preferred example is variant 4. Variant 5 describes the addition of a copolyamide for reducing the tendency of stress cracks of the layer of EVOH (EVAL® of KURARAY, see above).

The materials used in the context with these examples are as follows:

GRILON® R 50 H NZ is a heat stabilised, highly viscous, not reinforced, impact strength modified polyamide 6-extrusion blow moulding type (product designation according to ISO 1874:PA 6-HI, GH, 34-020). It is available at EMS-CHEMIE AG in Domat/Ems, Switzerland. It has a very high melting strength, a high impact strength also at low temperatures, and can be used for sequential and conventional extrusion blow moulding in combination with flexible types.

GRILON® ELX 50 H NZ is a heat stabilised, highly viscous, impact resistant polyamide 6-elastomer for extrusion blow moulding applications (product designation according to ISO 1874: PA 6/X-HI, BGH, 32-002). It is available at EMS-CHEMIE AG in Domat/Ems, Switzerland. It shows a high melting strength, a high impact resistance also at low temperatures and it can be used for sequential and conventional extrusion blow moulding.

GRILON® R 47 HW is a heat stabilised, highly viscous, impact resistant polyamide 6 for extrusion applications (product designation according to ISO 1874/1: PA 6-P, EHP, 27-005). It is available at EMS-CHEMIE AG in Domat/Ems, Switzerland. It shows a very high melt strength, a high impact resistance also at low temperatures and can be used for sequential and conventional extrusion blow moulding.

GRILON® ELX 23 NZ is a heat stabilised, highly viscous, impact resistant thermoplastic polyamide 6-elastomer for extrusion blow moulding applications (product designation according to ISO 1874:PA 6/X HI, EGR, 12002N). It is available at EMS-CHEMIE AG in Domat/Ems, Switzerland. It shows a very high melting strength, a high impact resistance also at low temperatures and can be used for sequential and coextruded extrusion blow moulding.

GRILAMID® L 25 W 20 X is a semi-flexible, softener comprising, highly viscous extrusion type on the basis of polyamide 12, it is impact strength modified and heat stabilised (product designation according to ISO 1874:PA 12-HIP, EHL, 22-005). It is available at EMS-CHEMIE AG in Domat/Ems, Switzerland. It shows a very high impact resistance also at low temperatures, is semi-flexible, shows a good resistance with respect to chemicals, has a low density and can be processed very easily. GRILON® CF 7 is a copolyamide 6/12 with a low melting point (product designation according to ISO 1874:PA6/12, FT, 18-010). It is available at EMS-CHEMIE AG in Domat/Ems, Switzerland. It shows high flexibility and strength, a good transparency, a low melting point as well as drawing properties and orientability. It has a polyamide 6-(caprolactame-) part of 55 weight- %.

The mentioned variants 1 to 5 where on the one hand subjected to a zinc chloride test and on the other hand to a sour-gas test. The specifications according to SAE XJ 2260 as well as according to Ford WSS-M 98D33-A3 were used as usual in this field.

Zinc chloride test:

Test according to SAE XJ 2260 paragraph 7.5, resistance to zinc chloride, and Ford WSS-M 98D33-A3 paragraph 3.4.5, resistance to zinc chloride, respectively.

Burst-pressure test (measured at room temperature =RT):

TABLE 2

| | | | SAEJ2260, | Ford, |
|---|---|---|---|---|
| | | | Treatment: | Treatment: 200 h at 60° C. |
| | Burst-pressure | As provided | 200 h at RT | Minimum requirement: 41.4 bar |
| Variant 1 | [bar] | 101.0 | 86.4 | 98.6 |
| Variant 2 | [bar] | 114.1 | 100.5 | Not met |
| Variant 3 | [bar] | 122.4 | 108.5 | Not met |
| Variant 4 | [bar] | 124.5 | 124.7 | 160.8 |
| Variant 5 | [bar] | 120.6 | 95.2 | 133.0 |

The values given in the column designated “as provided” relate to the identical tubes without pre-treatment with zinc chloride.

It can clearly be recognised that the preferred example, i.e. variant 4, shows outstanding properties compared to variants 1 to 3 according to the state-of-the-art.

Sour-gas test:

Test according to SAE XJ 2260 paragraph 7.8, auto-oxidized gasoline, and Ford WSS-M 98D33-A3 paragraph 3.4.10, oxidized fuel resistance (sour gas), respectively.

Cold impact test (impact test always carried out at −40° C.):

TABLE 3

| | | | SAEJ2260, PN 90 | Ford, PN 180 |
|---|---|---|---|---|
| | Impact test | As provided | Treatment: 1000 h at 40° C. | Treatment: 360 h at 60° C. |
| Variant 1 | [%] | No break | 80% break | No break |
| Variant 2 | [%] | No break | 90% break | No break |
| Variant 3 | [%] | No break | 90% break | 80% break |
| Variant 4 | [%] | No break | 10% break | 10% break |
| Variant 5 | [%] | No break | 20% break | 10% break |

Also under these conditions the superior properties of the preferred variant 4 can be recognized. Further substantial properties were measured using a tube exclusively made of GRILAMID® XE 3850 as well as using a tube according to variant 4, in particular in each case using a 8 ×1 mm tube (i.e. outer diameter 8 mm and wall thickness 1 mm), and are summarized in table 4:

TABLE 4

| | | | XE 3850 | | Variant 4 | |
|---|---|---|---|---|---|---|
| Property | Measurement condition | Unit | | VS* | | VS* |
| Burst-pressure | At 23° C. | [bar] | 110 | 38.5 | 124.5 | 43.6 |
| according to | At 80° C. | [bar] | 40.8 | 14.3 | 48.2 | 16.9 |
| DIN73378 | At 120° C. | [bar] | 30.5 | 10.7 | n.m.** | |

| | | | | |
|---|---|---|---|---|
| Burst-pressure | At 23° C. | [bar] | 104.2 | n.m.** |
| according to | | | | |
| SAEJ844d | | | | |
| | After ZnCl at RT 200 h | [bar] | 96.0 | 124.7 |
| | SAEJ844 d (requirement | | | |
| | 75% of RT Burst) | | | |
| Cold impact | At −40° C. | [ ] | No break | No break |
| according to | | | | |
| SAEJ2260 | | | | |
| Drawing test | Max. tensile stress | [MPa] | 38.0 | 43.5 |
| | Elongation | [%] | 12.0 | 8.9 |
| | Yield stress | [MPa] | 36.9 | 43.1 |
| | Breaking stress | [MPa] | 36.9 | 39 |
| | Elongation at break | [%] | 166.9 | 148.5 |

*The comparison stress (VS) in MPa as a quantity independent of the dimensions of the tube was determined based on the burst pressure of the tube using the formula given in paragraph 3.2 in DIN 73378: 1996-02.
**n.m.: not mesured

One can see that all the requirements according to DIN 73378 are met. Variant 4 given in table 4 in particular meets the zinc chloride test according to SAEJ844d. Variants 1-3 according to the state-of-the-art as given in table 1 do not comply with these requirements.

### Reference numerals

1 inner layer
2 intermediate layer
3 outer layer
4 thermoplastic multilayer composite
5 inner space
6 outer space

1-25. (cancelled)

26. A thermoplastic multilayer composite in the form of a hollow body comprising at least one inner layer, at least one intermediate layer, as well as at least one thermoplastic outer layer,
wherein the inner layer comprises a mixture of different polyamide-homopolymers, and wherein the inner layer may additionally comprise a compatibilizer.

27. A thermoplastic multilayer composite according to claim 26, wherein the inner layer is made of a mixture of at least two components,
wherein the first component is a polyamide-homopolymer selected from the group of polyamide 6 and polyamide 66, and
wherein the second component is a polyamide-homopolymer selected from the group of polyamide 12, polyamide 11, polyamide 1010, polyamide 1212 and polyamide 1012.

28. A thermoplastic multilayer composite according to claim 27, wherein the first component is polyamide 6.

29. A thermoplastic multilayer composite according to claim 28, wherein the second component is polyamide 12.

30. A thermoplastic multilayer composite according to claim 27, wherein the inner layer or material for the inner layer, respectively, is produced at a compounding temperature of at most 280° C. and at an extrusion temperature of at most 280° C.

31. A thermoplastic multilayer composite according to claim 30, wherein the compounding temperature and/or the extrusion temperature, respectively, are each at most 250° C.

32. A thermoplastic multilayer composite according to claim 31, wherein the compounding temperature and/or the extrusion temperature are each in a range between 230° C. to 240° C.

33. A thermoplastic multilayer composite according to claim 27, wherein the weight ratio of the first component to the second component is in a range between 2:3 to 3:2.

34. A thermoplastic multilayer composite according to claim 33, wherein the weight ratio of the first component to the second component is in a range between 2:3 to 1:1.

35. A thermoplastic multilayer composite according to claim 26, wherein the inner layer comprises a compatibilizer in a proportion in the range of 0-30 parts in weight, with reference to the total of parts in weight of polyamides and compatibilizer.

36. A thermoplastic multilayer composite according to claim 35, wherein the proportion of the compatibilizer is in the range of 0-20 parts in weight.

37. A thermoplastic multilayer composite according to claim 36, wherein the proportion of the compatibilizer is in the range of 5-15 parts in weight.

38. A thermoplastic multilayer composite according to claim 35, wherein the compatibilizer is an impact strength modifier, an elastomer or a rubber.

39. A thermoplastic multilayer composite according to claim 38, wherein the compatibilizer is an acid-modified ethylene/α-olefin-copolymer.

40. A thermoplastic multilayer composite according to claim 26, wherein the inner layer comprises a compatibilizer in a proportion in the range of 5-35 parts in weight, with reference to the total of parts in weight of polyamides and compatibilizer.

41. A thermoplastic multilayer composite according to claim 40, wherein the proportion of the compatibilizer is in the range of 8-30 parts in weight.

42. A thermoplastic multilayer composite according to claim 41, wherein the proportion of compatibilizer is in the range of 12-25 parts in weight.

43. A thermoplastic multilayer composite according to claim 26, wherein the intermediate layer is made of a material comprising polyamide 6, a copolyamide, a polyolefin, an ethylene/vinyl alcohol-copolymer, or a blend of at least two of these components.

44. A thermoplastic multilayer composite according to claim 43, wherein the intermediate layer is made of a material comprising copolyamide 6/12.

45. A thermoplastic multilayer composite according to claim 26, wherein the inner layer is located immediately adjacent to the intermediate layer.

46. A thermoplastic multilayer composite according to claim 45, wherein the intermediate layer is located immediately adjacent to the outer layer.

47. A thermoplastic multilayer composite according to claim 26, wherein there is provided at least one additional intermediate layer between the first intermediate layer and the inner layer; or between the first intermediate layer and the outer layer.

48. A thermoplastic multilayer composite according to claim 47, wherein the first intermediate layer is made of a material comprising ethylene/vinyl alcohol copolymer.

49. A thermoplastic multilayer composite according to claim 47, wherein the additional intermediate layer is made of a material comprising polyamide 6, a copolyamide, a polyolefin or a blend of at least two of these components.

50. A thermoplastic multilayer composite according to claim 49, wherein the copolyamide is copolyamide 6/12.

51. A thermoplastic multilayer composite according to claim 26, wherein the inner layer comprises anti-static additives, plasticizers, pigments, stabilizers, flame retardant additives or reinforcement.

52. A thermoplastic multilayer composite according to claim 26, wherein the multilayer composite is provided as a tube, and wherein the inner layer or a supplementary innermost layer comprises a polyamide blend and at least one electrically conductive additive.

53. A thermoplastic multilayer composite according to claim 26, wherein there is provided at least one intermediate layer comprising ethylene/vinyl alcohol-copolymer.

54. A thermoplastic multilayer composite according to claim 53, wherein the at least one intermediate layer further comprises additives for improving mechanical properties.

55. A thermoplastic multilayer composite according to claim 54, wherein the additives for improving mechanical properties improve impact strength, stress crack resistance, elongation at break or a combination thereof.

56. A thermoplastic multilayer composite according to claim 53, wherein the weight ratio of the first component of the outer layer to the second component of the outer layer is in the range between 2:3 to 3:2.

57. A thermoplastic multilayer composite according to claim 56, wherein the weight ratio of the first component of the outer layer to the second component of the outer layer is in the range between 2:3 to 1:1.

58. A thermoplastic multilayer composite according to claim 26, wherein the outer layer comprises a polyolefin or a thermoplastic elastomer.

59. A thermoplastic multilayer composite according to claim 26, wherein the outer layer comprises different polyamide-homopolymers.

60. A thermoplastic multilayer composite according to claim 59, wherein the polyamide is a mixture of at least two components, and wherein first component of the outer layer is a polyamide-homopolymer selected from the group of polyamide 6 and polyamide 66, and the second component of the outer layer is a polyamide-homopolymer selected from the group of polyamide 12, polyamide 11, polyamide 1010, polyamide 1212 and polyamide 1012.

61. A thermoplastic multilayer composite according to claim 59, wherein the polyamide homopolymer is a mixture of at least two components and wherein the first component of the outer layer is polyamide 6.

62. A thermoplastic multilayer composite according to claim 61, wherein the second component of the outer layer is polyamide 12.

63. A thermoplastic multilayer composite according to claim 59, wherein the outer layer additionally comprises a compatibilizer.

64. A thermoplastic multilayer composite according to claim 63, wherein the compatibilizer is in a proportion in the range between 0-30 parts in weight, with reference to the total of the parts in weight of polyamides and compatibilizer.

65. A thermoplastic multilayer composite according to claim 64, wherein the compatibilizer is in a proportion in the range between 0-20 parts in weight.

66. A thermoplastic multilayer composite according to claim 65, wherein the compatibilizer is in a proportion in the range between 5-15 parts in weight.

67. A thermoplastic multilayer composite according to any claim 59, wherein the outer layer comprises a compatibilizer in a proportion in the range of 5-35 parts in weight, with reference to the total of parts in weight of polyamides and compatibilizer.

68. A thermoplastic multilayer composite according to claim 67, wherein the compatibilizer is in a proportion in the range between 8-30 parts in weight.

69. A thermoplastic multilayer composite according to claim 68, wherein the compatibilizer is in a proportion in the range between 12-25 parts in weight.

70. A thermoplastic multilayer composite according to claim 63, wherein the compatibilizer of the outer layer is an impact strength modifier, an elastomer or a rubber.

71. A thermoplastic multilayer composite according to claim 70, wherein the compatibilizer of the outer layer is an acid-modified ethylene/α-olefin copolymer.

72. A method for producing a hollow body of a thermoplastic multilayer composite according to claim 26, which comprises joining the inner layer, the intermediate layer, as well as the outer layer and optionally additional intermediate layers in a coextrusion process to form the hollow body.

73. A method according to claim 72, wherein the hollow body is in the form of a hose, a pipe or a container.

74. A thermoplastic multilayer composite according to claim 26, wherein the thermoplastic multilayer composite is in the form of a tubing.

75. A tubing according to claim 74, wherein the tubing is suitable to be used with liquid fuel.
